(19) United States
(12) Patent Application Publication
(10) Pub. No.: US 2003/0032444 A1
(43) Pub. Date: Feb. 13, 2003

(54) Cellnet phone system alarm

(76) Inventors: Peter Daykin, Blackpool (GB); Jason Stephenson, Bolton (GB)

Correspondence Address: Peter S. Canelias, Attorney at Law, 14th Floor, 445 Park Avenue, New York, NY, 10022, US

(21) Appl. No.: 10/216,004

(22) Filed: Aug. 9, 2002

(30) Foreign Application Priority Data
Aug. 11, 2001 (GB) GB 0119667.4

(51) Int. Cl. H04M 1/00; H04B 1/38

(52) U.S. Cl. 455/550; 455/575

(57) ABSTRACT

A CELLNET phone system alarm that when triggered by an intruder automatically and silently rings out from a vehicle or premises with a pre-recorded voice message to one or more pre-set phone numbers. At the same time as the unit FIG. 1 gives out its message the unit FIG. 1 if secured in a vehicle can be tracked by the CELLNET phone company giving the approximate position of the vehicle.

### CLAIM FOR PRIORITY

This application claims the benefit of a United Kingdom patent application, application no. GB 0119667.4, filed Aug. 11, 2001.

### BACKGROUND OF THE INVENTION

This Alarm Unit FIG. 1 will use a cellnet phone system—a silent alarm in a vehicle or premises, whereby a voice message will be transmitted to inform the contact by telephone of an “alarm event”.

### BRIEF DESCRIPTION OF THE INVENTION

The Alarm Unit FIG. 1 will operate on a pre-paid SIM card. Lightweight and the size of a packet of king size cigarettes, the Alarm Unit FIG. 1 can be concealed and secured, as the product has no keypad and no display screen. The device can be used in many applications, such as motor vehicles, caravans, yachts and other moveable objects, commercial premises, domestic and holiday homes. When the Alarm Unit FIG. 1 is fitted in a vehicle it is connected to and charged by the vehicle's 12 volt system. The Alarm Unit FIG. 1 can also be connected by Output Port (4) to a burglar alarm, fire alarm, flood alarm and a panic alarm when fitted in premises.

The Alarm Unit FIG. 1 will store up to three, or more, telephone numbers. If, say, a vehicle is broken into, to steal the goods inside or the vehicle itself, the alarm will immediately and silently ring the first of those three numbers to advise the contact to investigate. After a preset time or number of rings (to be decided by the owner) without answer, it will ring the second number, and so on until the call is taken. Even after the call has been taken, the Alarm Unit FIG. 1 reverts to ringing the prime number to advise approximately every 30 minutes. The reason for this last procedure is so that the Alarm Unit FIG. 1 can be located from one cell to the next, by the cellnet phone company, so giving the approximate position of the vehicle.

### BRIEF DESCRIPTION OF THE DRAWINGS

FIG. 1 shows a side view of the whole device detailing:

1. Outer Casing

2, Lead “power in’

3. Dataport

4. Output Port to the alarm system, house or boat

5. Green coloured LED

6. Red coloured LED

7. Sliding Cover

FIG. 2 is a block diagram of the system

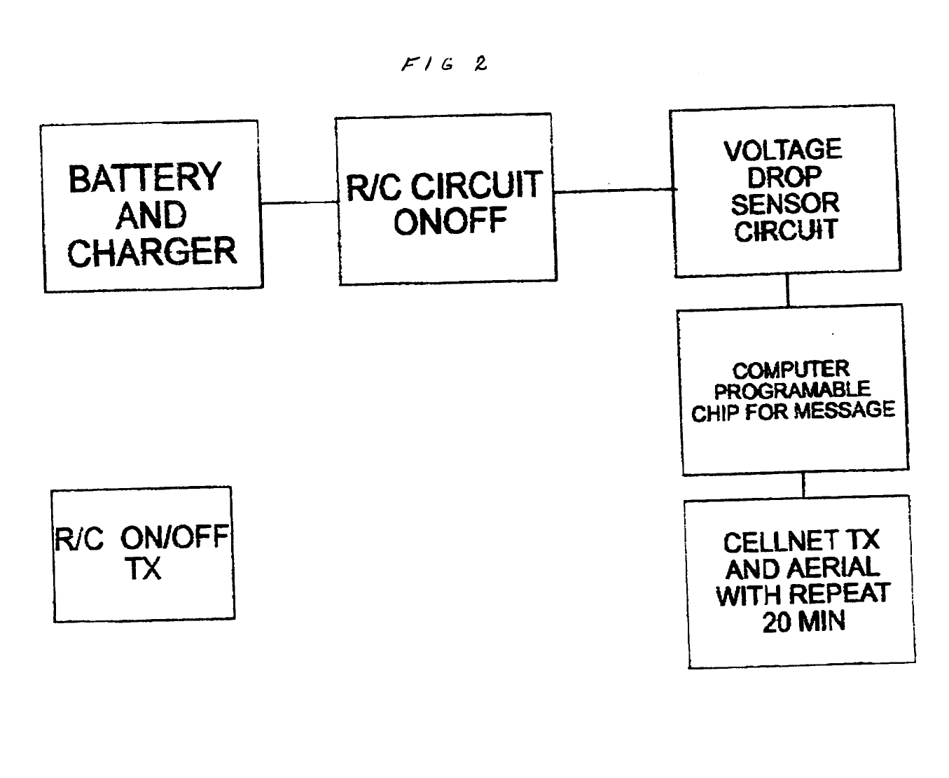

### DETAILED DESCRIPTION

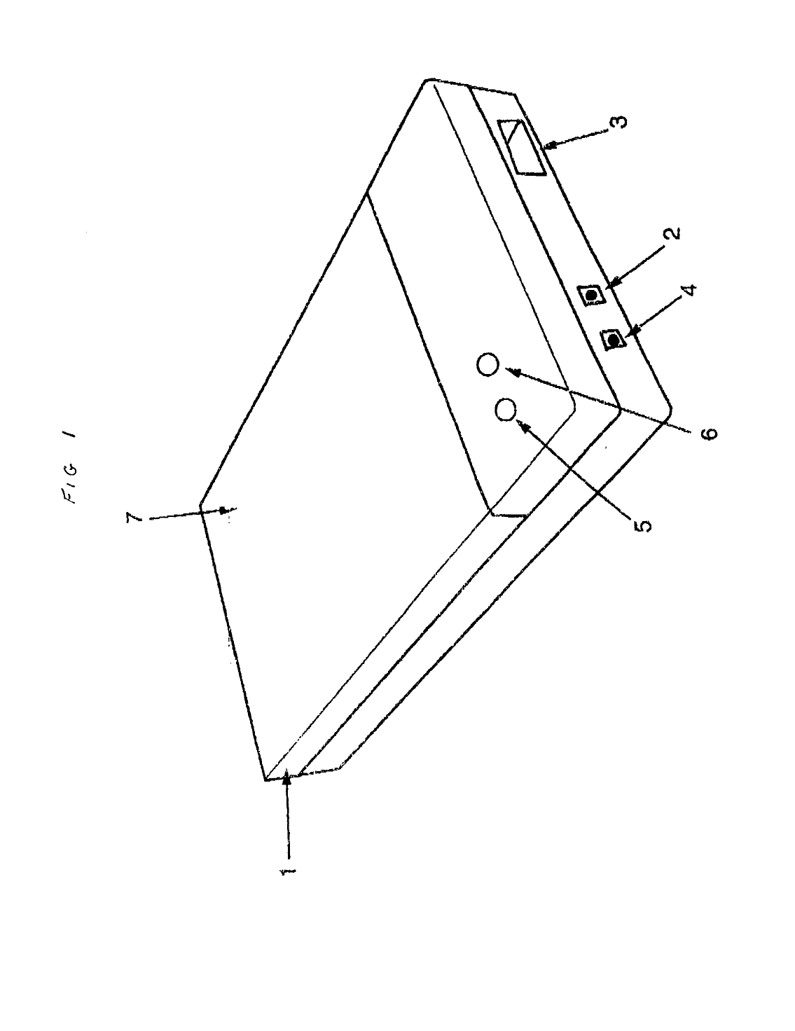

Of the Alarm Unit FIG. 1, the Outer Casing (1) will be made in strong high quality plastic. Because the product has no keyboard, display, microphone or speaker, protection against extreme temperature changes, water and shock resistance will easily be accomplished.

When connected by a Lead “power in” (2) to a 12 volt system, a voltage regulation unit provides the correct power to the Alarm Unit FIG. 1 components and the internal battery, so providing standby power for the device in the event that the 12 volt power is interrupted.

A Dataport (3) [Universal Serial Bus (USB) or parallel port] allows for the transfer from a computer of the various options from a menu:

telephone numbers to ring,

The recorded voice message

mode—fixed premises or vehicle,

ring out times per number and various time delays.

Software will be supplied for computers on CD ROM. This will include the facility to record an individual message. A micro processor will coordinate all control and supervisory actions of the Alarm Unit FIG. 1, including operating the speech synthesis circuitry, tracking the system status and maintaining memories and the SIMcard status.

When the alarm Unit FIG. 1 is fitted to a vehicle or premises, a coded remote key fob will be used to arm and disarm the Alarm Unit FIG. 1.

The Alarm Unit FIG. 1 will only send out a phone message alarm, it will not receive a call or data. This gives the Alarm Unit FIG. 1 a hardware firewall against intrusion.

When the device is installed, a Green Coloured LED (5) will indicate that it is “live”. Once the alarm is set, a Red Coloured LED (6), flashing intermittently will indicate that the device is activated. An alarm event occurs when there is a small voltage drop, caused in any one of three ways

1. The interior light comes on

2. the alarm goes off, or

3. when the engine is started

A Sliding Cover 7 will be used to gain access to the interior of the Alarm Unit FIG. 1 in order to insert the SIMcard and batteries.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A CELLNET phone alarm that has no keypad, display, microphone nor speaker. A dataport allows for transfer from a computer of various options from a menu, telephone numbers to ring; the recorded voice message or data; premises or vehicle mode; ring out times per number and time delays. The unit has a hardware firewall against intrusion and will only send out a phone message. The phone alarm will not receive a call or data.

2. A CELLNET phone alarm as in claim 1 wherein means are provided for an output port to an existing alarm system or an alarm event that occurs when there is a small voltage drop in a vehicle.

3. A phone alarm as claimed in claim 1 and 2 wherein means are provided for a power in socket to an internal voltage regulation unit to provide the correct power to the phone alarm and internal battery, providing backup power.

4. A phone alarm as claimed in the preceding claims when fitted to a vehicle or premises a coded remote keyfob would be used to arm and disarm the unit.

5. The phone alarm as claimed in the preceding claims wherein an option is provided that the unit when fitted to a vehicle would continue to ring out on the prime phone number even after the call has been taken. The unit can then be tracked giving the position of a vehicle.

6. A CELLNET phone alarm as claimed in any preceding claim wherein the unit it fitted with a green LED to indicate the unit is live and a red LED flashing intermittently to indicate that the device is activated.

7. A CELLNET phone alarm as claimed in any preceding claim that has a case made from strong high quality plastic and a sliding cover to gain access to the interior in order to insert the SIMcard and battery as substantially described and shown in the accompanying drawing—FIG. 1.
